(19) United States
(12) Patent Application Publication
(10) Pub. No.: US 2003/0169292 A1
(43) Pub. Date: Sep. 11, 2003

(54) Dynamically filling web lists

(75) Inventors: David J. Carew, Austin, TX (US); Hung T. Dinh, Round Rock, TX (US); Teng S. Hu, Austin, TX (US); Mansoor A. Lakhdhir, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, Armonk, NY (US)

(21) Appl. No.: 10/093,439

(22) Filed: Mar. 7, 2002

(51) Int. Cl. G09G 5/00

(52) U.S. Cl. 345/760

(57) ABSTRACT

A method for dynamically filling web lists, including creating, in an HTML document as a Select element in a Forms element, a dynamic list element, wherein the dynamic list element comprises an HREF parameter, assigning, to the HREF parameter in the dynamic list element, a network address comprising the location of a list in a central repository, and displaying, through a user interface on a web enabled device coupled for data communications to the central repository, a listbox for the Forms element. The method also including selecting the listbox through the user interface, and retrieving, from the location in the central repository identified by the network address, the list from the central repository.

### BACKGROUND OF THE INVENTION

Inventors:

Lakhdhir Mansoor
Hung Dinh
Teng Hu
David Carew

1. Field of the Invention

The field of the invention is data processing, or, more specifically, methods, systems, and products for dynamically filling web lists.

2. Description of Related Art

Typically in web based HTML forms, lists of items are sent from a server to a client browser. An example would be a list of countries from which a user is expected to make a selection. If an item in the list is changed, then all the forms that contain the list need to be changed & tested, possibly by more than one software developer responsible for those forms. Also, if the forms are translated to other languages, then all those translated forms need to be reworked. There is potential for errors while all these HTML forms are changed by various programmers, developers, or web page designers. Additionally, if a listbox selection is optional, or will not be modified by a user during an editing session, it is inefficient to transmit the contents of the list from the server to the client & pre-load that listbox. For these reasons, it is seen that it would be beneficial to have ways of storing in a central repository only one list for a listbox to be used in many listboxes in many GUIs on many web pages, implemented so that the list is downloaded only when invoked or selected by a user taking action in a GUI on a web page.

### SUMMARY OF THE INVENTION

Exemplary embodiments of the invention typically include methods for dynamically filling web lists, including creating, in an HTML document as a component of a Select element in a Forms element, a dynamic list element, in which the dynamic list element includes an HREF parameter. Exemplary embodiments typically include assigning, to the HREF parameter in the dynamic list element, a network address including the location of a list in a central repository, and displaying, through a user interface on a web enabled device coupled for data communications to the central repository, a listbox for the Forms element. Some embodiments include selecting the listbox through the user interface, and retrieving, from the location in the central repository identified by the network address, the list from the central repository.

Embodiments of the invention typically include storing the list in the central repository, and displaying the list through the listbox in the user interface. In many embodiments, the user interface includes a graphical user interface (“GUI”). In many embodiments, the central repository comprises a web server, and storing the list on the central repository includes storing the list in a database accessible through a web server.

In typical embodiments, the network address comprises a URL In some embodiments, the network address typically comprises a URL. In exemplary embodiments, displaying the listbox is typically carried out when, in a process of interpreting the HTML document, an HTLM interpreter interprets the Form element. In many embodiments, the HTML interpreter is comprised within a browser, and selecting the listbox typically includes touching the listbox with a GUI pointer. In some embodiments, selecting the listbox includes clicking the listbox with a mouse pointer.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a control flow diagram illustrating typical example embodiments of the invention. FIG. 2 is a block diagram showing data communications relations among a client with a browser, a web server, and a database server.

### DETAILED DESCRIPTION OF EXEMPLARY EMBODIMENTS

### Introduction

The present invention is described to a large extent in this specification in terms of methods for dynamically filling web lists. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product typically are implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“Browser” means a web browser, a software application for locating and displaying web pages. Browsers typically comprise both an HTML interpreter and an HTTP communications client. Typical browsers today can display text, graphics, audio and video.

“Network” is used in this specification to mean any networked coupling for data communications. Examples of networks useful with the invention include intranets, extranets, internets, local area networks, wide area networks, and other network arrangements as will occur to those of skill in the art. The use of any networked coupling from client devices to one or more transcoding gateway servers is well within the scope of the present invention.

“Server” in this specification refers to a computer or device comprising automated computing machinery on a network that manages network resources. In this sense, transcoding gateways in some embodiments are servers that manage network traffic; in some embodiments of the present invention, such network traffic includes email messages, HTML documents, and digital objects. Typical digital objects include JPEG files, MPEG files, MP3 files, GIF files, and so on.

A “URI” or “Universal Resource Identifier” is an identifier of a named object in any namespace accessible through a network. URI are functional for any access scheme, including for example, the File Transfer Protocol or “FTP,” Gopher, and of course the “web,” the “World Wide Web.”

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Embodiments of the present invention, generally utilize identifiers that need to resolve to addresses because embodiments of the present invention typically need to retrieve lists from particular addresses in central repositories. For this reason, although URIs are equally useful as identifiers of list addresses, we speak generally in this disclosure of list addresses as being indicated by URLs.

A URL typically includes an internet protocol address, or a domain name that resolves to an internet protocol address, identifying a location where a resource is located on a network. URLs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, a URL often includes execution parameters.

“World Wide Web,” or more simply “the web,” refers to the well-known system of internet protocol (“IP”) servers that support specially formatted documents, documents formatted in a language called “HTML” for HyperText Markup Language. The term “Web” is used in this specification also to refer to any server or connected group or interconnected groups of servers that implement the HyperText Transport Protocol, “HTTP,” in support of URLs and HTML documents, regardless whether such servers or groups of servers are coupled to the world wide web as such.

### Detailed Description

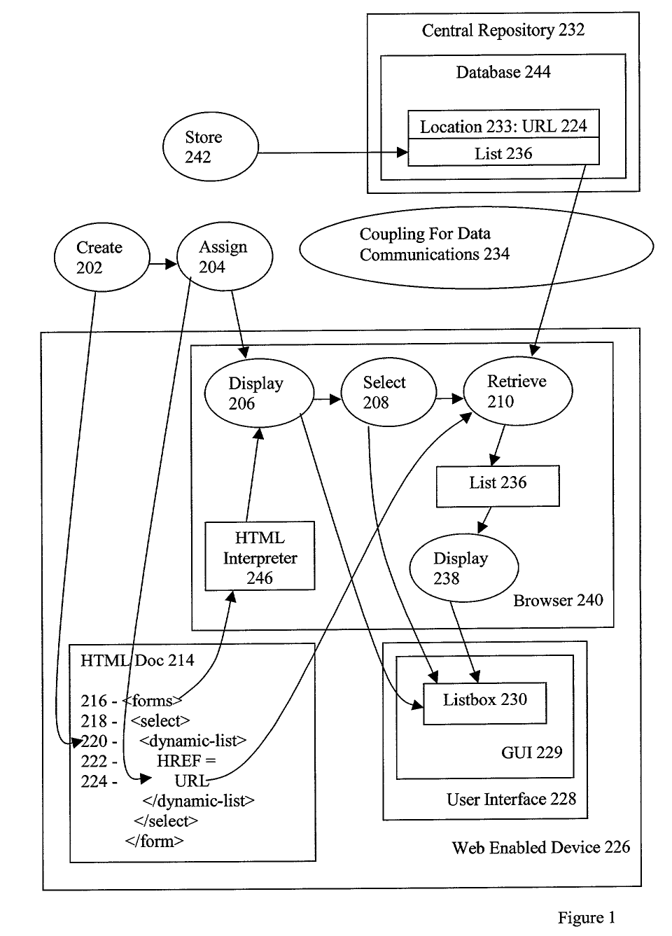

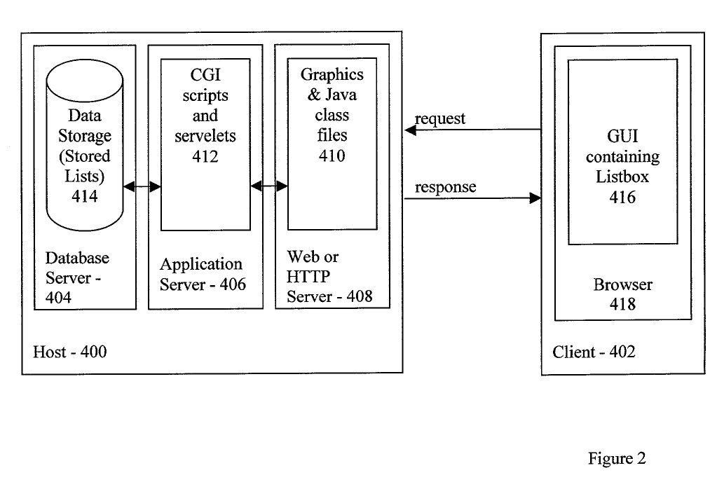

Turning now to FIG. 1, exemplary embodiments of the invention are seen to include methods for dynamically filling web lists. Embodiments typically include creating (202), in an HTML document (214), a dynamic list element (220), in which the dynamic list element includes an HREF parameter (222) . A dynamic list element so created typically is implemented in HTML documents by use of a <dynamiclist> begin tag and a <dynamiclist> end tag. The HREF parameter, like other HTML HREF parameters, accepts URLs as parameter values.

Exemplary embodiments typically include assigning (204), to the HREF parameter (222) in the dynamic list element (220), a network address (224) including the location (233) of a list (236) in a central repository (232), and displaying (206), through a user interface (228) on a web enabled device (226) coupled for data communications (234) to the central repository (232), a listbox (230) for the Forms element (216). Embodiments typically include selecting (208) the listbox (230) through the user interface (228), and retrieving (210), from the location (233) in the central repository (232) identified by the network address (224), the list (236) from the central repository (232).

Exemplary embodiments of the invention typically include storing (242) the list in the central repository. Such embodiment typically include displaying (238) the list through the listbox (230) in the user interface (228). In some embodiments, the user interface includes a graphical user interface (“GUI”) (229). In typical embodiments, the central repository (232) comprises a web server, and storing (242) the list on the central repository in many embodiments includes storing the list in a database (244) accessible through a web server.

More particularly, many embodiments support database access as illustrated by reference to FIG. 2, a diagram illustrating components and data flow used to provide communication between a client and a host is depicted in accordance with an exemplary embodiment of the present invention. In the example illustrated in FIG. 2, communication is provided between host (400) and client (402). The client starts a transaction by issuing an HTTP ‘Request’ to the server. The server responds back to the client with a “Response”. In this example, host (400) includes a database server (404), an application server (406), and a web server (408). Web server (408) also is referred to as an HTTP server. Web server (408) handles all the HTTP requests coming into a website. Then, web server (408) hands off the request to the application server (406), which then talks to the database server (404) if necessary to access data or write data. Also, all responses from the website go out, to the client, through web server (408).

Web server (408) also includes a directory that contains the Java class files for applets and the graphics files such as .gifs, .jpegs, etc. These are shown as (410). Application server (406) runs the Common Gateway Interface (CGI) scripts. This server typically also has a servlet engine to run JAVA servlets. In this example, application server (406) contains CGI scripts and JAVA servlets (412). Database server (404) is used to store and access data, such as in data storage (414). These three servers (daemon processes) can all run on one machine or each server can run on its own separate dedicated machine.

The data storage (414) stores the contents for lists supported by the host (400). The GUI contains a Listbox (416). There are many different ways in which the contents of the list may be stored for use by the present invention. The present invention is intended to encompass all possible list storage mechanisms and methods. However, as an example of one embodiment, the list table may be stored on a backend DB2 application database table. DB2 is a Relational Database Management System (RDBMS), available from International Business Machines, Inc., that is a full-featured Structured Query Language (SQL) language RDBMS.

The GUI HTML form that contains the Listbox (416) uses HyperText Transport Protocol (HTTP) to create and open a Uniform Resource Locator (URL) connection to a CGI program or servlet on host (400). In this example, the communication is to a CGI script or a servlet (412). When invoking the CGI script or a servlet (412), some parameters maybe passed to these programs through the use of a “Path info” and/or “Query string.” These parameters maybe optionally included in the URL used to establish the connection. The value of these parameters maybe used to cause the CGI script or a servlet (412) to execute a selected operation on the data. The “path info” or “Query string” is part of the URL string, and as such is sent to the host, or more appropriately to the CGI script or servlet at the host, as part of the creation of the URL connection. Next, the servlet or CGI script (412) uses this data to query the data storage (414). There are a number of ways in which a JAVA servlet can communicate with the database. Some of the common methods are JDBC (Java DataBase Connectivity) APIs, RMI (Remote Method Invocation) and CORBA (Common Object Request Broker Architecture). Next, data will be returned to the Listbox 416 by the CGI script or a servlet.

In many exemplary embodiments, the network address (224) typically comprises a URI. In many such embodiments, the network address (224) comprises a URL.

As explained in more detail below, in many embodiments, creating (202) a dynamic list element (220) further comprises creating a dynamic list element as a component of an HTML Select element (218) in an HTML Form element (216). In exemplary embodiments, displaying the listbox typically is carried out when, in a process of interpreting an HTML document, an HTLM interpreter (246) interprets the Form element. The HTML interpreter in typical embodiments is comprised within a browser (240).

Selecting the listbox typically includes touching the listbox with a GUI pointer. A GUI pointer is any device or method for indicating or selecting objects represented in a GUI. In many embodiments, selecting the listbox includes clicking the listbox with a mouse pointer. In fact, a mouse pointer is an example of a GUI pointer. Other examples of GUI pointers include styli pressed on touch sensitive screens on personal digital assistants or “PDAs,” as well as human fingers pressed on touch sensitive screens on computer monitors in airport kiosks. Persons of skill in the art will think of many alternative forms of GUI pointers and the use of all of them as GUI pointers is well within the scope of the present invention.

In HTML forms, lists are commonly used to allow a user to select predefined items. An example would be to select the name of a country as part of a shipping address. So, for example in the HTML source of the following URL, http://ircalc.usps.gov/weight.asp?Contents=1, which identifies a web page that implements an international postage rate calculator of the United States Postal Service, the following excerpted HTML code is seen to populate the Country listbox for the postage rate calculator:

<form method=get action=speed.asp>

<FONT face=Arial color=#ff0000>

<b>1. To which country are you mailing?</b>

</font><br><br>
<select tabindex=1 name=Country accesskey=‘s’
label=‘Select a country’ size=1>

<option>Select a Country</option>
<option value=‘United Arab Emirates’>Abu Dhabi (United
Arab
Emirates)</option>
<option value=‘Papua New Guinea’>Admiralty Islands (Papua
New
Guinea)</option>
<option value=‘Afghanistan’>Afghanistan</option>
<option value=‘Finland’>Aland Island (Finland)</option>
<option value=‘Albania’>Albania</option>
. . .
<option value=‘Zambia’>Zambia</option>
<option value=‘Tanzania’>Zanzibar (Tanzania)</option>
<option value=‘Zimbabwe’>Zimbabwe</option>

</select>
. . .

</form>

The excerpt just above is standard HTML In standard HTML, the Select element creates a menu. Each choice offered by such a menu in standard HTML is represented by an Option element. In many such menus, there are hundreds of Option elements, one for each item in the list displayed in the menu. Notice, in the excerpt just above, for example, the repetitious use of the HTML <option value= . . . > tag and the large amount of data sent from server to client to populate the Country listbox. Typical example embodiments of the present invention, however, replace the above hard-coded list and the multiplicity of Option elements with the following HTML code:

<form method=get action=speed.asp>

<select name=Country size=1>

<DynamicList>

HREF=“URI location”

</DynamicList>

</select>

</form>

The dynamic list tag named, through its included HREF and network address, usually implemented as a URL, points in cyberspace to a predefined, configurable collection of items in a list. In the Postal Service example excerpted above, the list items are names of countries. In this manner, the dynamic list element is used only once in the above example, thus reducing code clutter and programming errors.

More specifically, embodiments of this kind typically include the creation of a dynamic list element to point to the URI location that contains the list. Note the similarity of the syntax to anchor blocks for creating links on web pages. Examples of objects so linked through such references are image maps, tables, and so on.

The dynamic list tag is created in several ways in various embodiments. In embodiments direct toward Internet Explorer, the dynamic list tag is created by use of DHTML scriptlets or by use of custom ‘behaviors.’ In embodiments directed toward browsers that support XML, the dynamic list tag is created as a user-defined XML tag. For more details regarding scriptlets and behaviors, readers are directed to the Microsoft Developer Network article entitle “Understanding Scriptlets and Behaviors” at

http://msdn.microsoft.com/library/default.asp?url=/library/en-us/modcore/html/deovrUnderstandingScriptletsBehaviors.asp.

For more detail regarding XML, readers are directed to the World Wide Web Consortium's specification entitled “Extensible Markup Language (XML) 1.0 (Second Edition)” at http://www.w3.org/TR/REC-xml. Many ways of implementing the dynamic list tag will occur to those of skill in the art, and all such ways are well within the scope of the present invention.

In typical embodiments, the <DynamicList> tag is used to create the list-box GUI control on a web-page. The “URI location” in some embodiments is an absolute URI (as opposed to a relative URI) to point to a central server in an organization that contains the list of predefined countries in a domain table in a central relational database. Identification of the database server and the table column containing the dynamic data in such embodiments typically is encoded in the URI pointed to by an HREF attribute on the <DynamicList> tag. An example of a relational database is the DB2 program product from IBM Corporation.

In typical operation of such exemplary embodiments, when a user selects the drop-down listbox, the web browser recognizes the <DynamicList> tag within the <select> tag. The browser then sends a request, in the form of an HTTP request message, for the list to the central repository, which is typically implemented as a web server coupled for data queries to a database server. The web server in such embodiments typically is the server specified by the “URI location” or HREF parameter of the <DynamicList> tag. The web server responds with the data comprising the list, which the browser uses to format, fill and display the listbox contents.

No special browser enhancements are typically required to cause the browser to format, fill, and display the list in the listbox of the <form> element because in typical embodiments the web server is enhanced to respond with a list of <option> elements comprising the values of the data returned to the web server when it made a query call to the database server to retrieve the contents of the list.

More particularly, in typical embodiments, the dynamic list element is processed as a Server Side Include (SSI). Server side includes are snippets of HTML that are included into a containing HTML document by a web server before the a requested document is returned to a client. The following is an example of a Server Side Include that is used as a counter for web pages served by the Apache Web Server.

<!--#include virtual=“/cgi-bin/counter.pl” -->

This example outputs the results of a CGI program written in Perl, a ‘hit counter,’ a well known application for counting web page accesses. The result of a call to the Perl program is returned to the browser as well as the remaining HTML in the document that contains the Server Side Include.

The dynamic list element is processed in a similar way in typical embodiments of the present invention. That is, the browser receives in response from the web server a list of <option> elements that represents the values of the data returned from the database server when it queried a database server to retrieve the contents of the list identified in the dynamic list tag. In such embodiments, the browser does no special processing to support dynamic lists. The processing of a dynamic list element in such embodiments is a special case of a Server Side Include that returns a dynamic list from a database in the appropriate format of a list of options in an HTML FORM.

Although we presented in this specification the example of a list of countries, readers of skill in the art will immediately recognize that embodiments of the invention administer any predefined web based selection list including, for example, any configurable lists in HTML forms such as languages, U.S. states, U.S. cities, currencies, and so on.

As can be seen from the detailed discussion above, embodiments of this invention typically provide the advantage that only one instance of a web list is stored in a central repository. In many embodiments, this single central storage is implemented as a domain table in a relational database under the central control of a single DBA (Data Base Administrator). Typically in such embodiments, the web list so centrally stored provides the advantage of simple reference by HTML form developers who have a need to place this list on a web form. Hence it is an advantage of typical embodiments of this invention that their use simplifies and reduces errors in the creation and maintenance of web-based HTML forms. Further, Listbox controls for the list in typical embodiments are only filled when a user begins work with a particular Listbox, thus saving the wasteful overhead of downloading the list every time a surrounding web page is invoked. In addition, because the lists are transmitted from the server to the client only when needed, the end-user experience is enhanced due to the reduction in network traffic and improved browser performance.

It will be understood from the foregoing description that many and various modifications and changes are made and will be made in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method for dynamically filling web lists, the method comprising the steps of:
creating, in an HTML document, a dynamic list element, wherein the dynamic list element comprises an HREF parameter;
assigning, to the HREF parameter in the dynamic list element, a network address comprising the location of a list in a central repository,
displaying, through a user interface on a web enabled device coupled for data communications to the central repository, a listbox for the Forms element;
selecting the listbox through the user interface;
retrieving, from the location in the central repository identified by the network address, the list from the central repository.

2. The method of claim 1 further comprising storing the list in the central repository.

3. The method of claim 1 further comprising displaying the list through the listbox in the user interface.

4. The method of claim 1 wherein the user interface comprises a graphical user interface (“GUI”).

5. The method of claim 1 wherein the central repository comprises a web server.

6. The method of claim 1 wherein storing the list on the central repository further comprises storing the list in a database accessible through a web server.

7. The method of claim 1 wherein the network address comprises a URL

8. The method of claim 1 wherein the network address comprises a URL

9. The method of claim 1 wherein creating a dynamic list element further comprises creating a dynamic list element as a component of an HTML Select element in an HTML Forms element.

10. The method of claim 9 wherein displaying the listbox is carried out when, in a process of interpreting the HTML document, an HTLM interpreter interprets the Form element.

11. The method of claim 10 wherein the HTML interpreter is comprised within a browser.

12. The method of claim 1 wherein selecting the listbox comprises touching the listbox with a GUI pointer.

13. The method of claim 1 wherein selecting the listbox comprises clicking the listbox with a mouse pointer.

14. A system for dynamically filling web lists, the system comprising:
means for creating, in an HTML document as a Select element in a Forms element, a dynamic list element, wherein the dynamic list element comprises an HREF parameter;
means for assigning, to the HREF parameter in the dynamic list element, a network address comprising the location of a list in a central repository,
means for displaying, through a user interface on a web enabled device coupled for data communications to the central repository, a listbox for the Forms element;
means for selecting the listbox through the user interface;
means for retrieving, from the location in the central repository identified by the network address, the list from the central repository.

15. The system of claim 14 further comprising means for storing the list in the central repository.

16. The system of claim 14 further comprising means for displaying the list through the listbox in the user interface.

17. The system of claim 14 wherein the user interface comprises a graphical user interface (“GUI”).

18. The system of claim 14 wherein the central repository comprises a web server.

19. The system of claim 14 wherein means for storing the list on the central repository further comprises means for storing the list in a database accessible through a web server.

20. The system of claim 14 wherein the network address comprises a URL

21. The system of claim 14 wherein the network address comprises a URL

22. The system of claim 1 wherein means for creating a dynamic list element further comprises means for creating a dynamic list element as a component of an HTML Select element in an HTML Forms element.

23. The system of claim 22 wherein means for displaying the listbox is utilized when, in a process of interpreting the HTML document, an HTLM interpreter interprets the Form element.

24. The system of claim 23 wherein the HTML interpreter is comprised within a browser.

25. The system of claim 14 wherein means for selecting the listbox comprises means for touching the listbox with a GUI pointer.

26. The system of claim 14 wherein means for selecting the listbox comprises means for clicking the listbox with a mouse pointer.

27. A computer program product for dynamically filling web lists, the computer program product comprising:
a recording medium;
means, recorded on the recording medium, for creating, in an HTML document as a Select element in a Forms element, a dynamic list element, wherein the dynamic list element comprises an HREF parameter;
means, recorded on the recording medium, for assigning, to the HREF parameter in the dynamic list element, a network address comprising the location of a list in a central repository,
means, recorded on the recording medium, for displaying, through a user interface on a web enabled device coupled for data communications to the central repository, a listbox for the Forms element;
means, recorded on the recording medium, for selecting the listbox through the user interface;
means, recorded on the recording medium, for retrieving, from the location in the central repository identified by the network address, the list from the central repository.

28. The computer program product of claim 27 further comprising means, recorded on the recording medium, for storing the list in the central repository.

29. The computer program product of claim 27 further comprising means, recorded on the recording medium, for displaying the list through the listbox in the user interface.

30. The computer program product of claim 27 wherein the user interface comprises a graphical user interface (“GUI”).

31. The computer program product of claim 27 wherein the central repository comprises a web server.

32. The computer program product of claim 27 wherein means, recorded on the recording medium, for storing the list on the central repository further comprises means, recorded on the recording medium, for storing the list in a database accessible through a web server.

33. The computer program product of claim 27 wherein the network address comprises a URI.

34. The computer program product of claim 27 wherein the network address comprises a URL.

35. The computer program product of claim 27 wherein means for creating a dynamic list element further comprises means, recorded on the recording medium, for creating a dynamic list element as a component of an HTML Select element in an HTML Forms element.

36. The computer program product of claim 27 wherein means, recorded on the recording medium, for displaying the listbox is utilized when, in a process of interpreting the HTML document, an HTLM interpreter interprets the Form element.

37. The computer program product of claim 36 wherein the HTML interpreter is comprised within a browser.

38. The computer program product of claim 27 wherein means, recorded on the recording medium, for selecting the listbox comprises means, recorded on the recording medium, for touching the listbox with a GUI pointer.

39. The computer program product of claim 27 wherein means, recorded on the recording medium, for selecting the listbox comprises means, recorded on the recording medium, for clicking the listbox with a mouse pointer.
